(19) United States
(12) Patent Application Publication
(10) Pub. No.: US 2008/0049676 A1
(43) Pub. Date: Feb. 28, 2008

(54) METHOD AND SYSTEM FOR RESOURCE ALLOCATION IN A WIRELESS COMMUNICATION NETWORK

(75) Inventor: Zhixian Xiang, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 11/733,752

(22) Filed: Apr. 10, 2007

Related U.S. Application Data
(60) Provisional application No. 60/839,765, filed on Aug. 23, 2006.

(51) Int. Cl. H04Q 7/00

(52) U.S. Cl. 370/331

(57) ABSTRACT

Method and system for resource allocation in a wireless communication network. According to an embodiment, the present invention provides a method for providing allocation of resources in a wireless communication network. The method includes providing network access to a wireless device by a first access network. The method includes sending a handover request from the first access network to a plurality of candidate target networks at a first time. The plurality of target networks includes at least a second access network and a third access network. The method includes providing at least a timer that is associated with the first time and a second time. The method includes a step for causing an allocation for network resources by the plurality of the candidate target networks in response to the handover request. Moreover, the method includes a step for selecting the second access network as a selected target network.

### CROSS-REFERENCES TO RELATED APPLICATIONS

This application claims priority to U.S. Provisional Application No. 60/839,765 filed Aug. 23, 2006, which is incorporated by reference herein.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates in general to telecommunication techniques. More particularly, the invention provides a method and system for providing allocation of network resources. In a specific embodiment, the present invention provides a method and system for access networks that are potential candidates of handover operations to deallocate network resources under certain predetermined conditions. Merely by way of example, the invention is described as it applies to wireless access network, but it should be recognized that the invention has a broader range of applicability.

Techniques for wireless communications have progressed through the years. For example, satellite wireless communication networks have been developed where satellites are use to relay voice communication among wireless. There are other techniques as well. Over the recent years, the “cellular” wireless communication networks have become one of the most widely used technique for providing wireless communication.

A wireless network usually includes base stations and mobile stations. For example, a mobile station (MS) refers to a station that is to be used while in motion or during halts at unspecified geographic locations. As an example, the mobile station is a mobile communication device. In another example, the mobile station is a cellular phone. In yet another example, a base station (BS) refers to a set of equipment that can provide connectivity, management, and control for one or more mobile stations. As merely an example, a connective service network refers to a set of network functions that provide IP connectivity services to mobile stations. In an exemplary process flow, a MS obtains radio access from a BS. Through the BS, the MS obtains IP services.

In a telecommunication network, a mobile station is typically connected to a local network, which provides, among other things, radio connectivity. The local network also establishes a connection between the mobile station and a network where a variety of services (e.g., routing, Internet protocol routing, etc.) are provided. FIG. 1 is a simplified diagram illustrating a conventional telecommunication network. As an example, the conventional telecommunication network 100 as illustrated in FIG. 1 complies with WiMAX wireless (i.e., IEEE802.16d/e) networks.

In the, a mobile station 101, which is sometimes referred to as mobile subscriber station when the mobile station is subscribed to a specific network service provider, is connected to an access service network. For example, the mobile station 101 is connected to the access service network (ASN) 102. For example, the ASN 102 is configured to provide radio access to the mobile station 101. According to an embodiment, the ASN 102 includes a base station (BS) for providing radio access. For example, the BS refers to a generalized equipment set for providing connectivity, management, and control of mobile stations. In addition, the ASN 102 includes a gateway for interfacing with other networks. For example, the gateway allows the mobile station 101 to communicate with other ASNs (e.g., ASN 106). As another example, the gateway allows the mobile station 101 to connect to a connectivity service network (CSN) 104. As an example, the connectivity service network refers to a set of network functions that provide, among other things, IP connectivity service to mobile stations. Often, the CSNs also store policies associated with mobile stations.

Typically, a mobile station connects to a CSN that stores the network policies associated with the mobile station through an ASN. As an example, the CSN is often referred as network service provider from a management perspective. Similarly, the ASN is often referred to as network access provider from a management perspective.

When a MS is connected to a first ASN, the MS may needs to switch to a second ASN. Typically, the first ASN is referred as a serving ASN, and the second ASN is referred as a target ASN. The MS may switch from the serving ASN to the target ASN for a variety of reasons. For example, the MS may need to switch to ASN when the MS moves from one geological service area to another. For the MS to smoothly switch to a different location without interruption of network connection, a handover (HO) process is typically required.

Over the past, various conventional HO techniques have been developed. Unfortunately, these techniques are often inadequate.

Therefore, an improved method for providing wireless communication network is desired.

### BRIEF SUMMARY OF THE INVENTION

The present invention relates in general to telecommunication techniques. More particularly, the invention provides a method and system for providing allocation of network resources. In a specific embodiment, the present invention provides a method and system for access networks that are potential candidates of handover operations to deallocate network resources under certain predetermined conditions. Merely by way of example, the invention is described as it applies to wireless access network, but it should be recognized that the invention has a broader range of applicability.

According to an embodiment, the present invention provides a method for providing allocation of resources in a wireless communication network. The method includes providing network access to a wireless device by a first access network. the method also includes sending a handover request from the first access network to a plurality of candidate target networks at a first time. The plurality of target networks includes at least a second access network and a third access network. The method additionally includes providing at least a timer that is associated with the first time and a second time. The method further includes a step for causing an allocation for network resources by the plurality of the candidate target networks in response to the handover request. Moreover, the method includes a step for selecting the second access network as a selected target network. In addition, the method includes a step for causing a release of at least a portion the network resources by the third access network at the second time.

According to another embodiment, the present invention provides a method for providing allocation of resources in a wireless communication network. The method includes a step for providing a network access to a wireless device by a first access network. The method further includes sending a handover request from the first access network to a plurality of candidate target networks at a first time. The plurality of target networks includes a second access network and a third access network. The method further includes a step for sending pre-registration requests from the plurality of candidate target networks to an anchor access network. In addition, the method includes a step for causing a reservation for network resources for the second access network and the third access network by the anchor access network. Moreover, the method includes a step for selecting the second access network as a selected target network. Furthermore, the method includes sending a registration request by the second access network to the anchor access network. The method also includes a step for allocating the network resources for the second access network by the anchor access network. Furthermore, the method includes causing a release of network resources reserved for the third access network by the anchor access network. The releasing network resources is associated with the registration request.

According to yet another embodiment, the present invention provides a method for providing allocation of resources in a wireless communication network. The method includes a step for providing a network access to a wireless device by a first access network. The method additionally includes sending a handover request from the first access network to a plurality of candidate target networks at a first time. The plurality of target networks includes at least a second access network and a third access network. The method further includes sending pre-registration requests from the plurality of candidate target networks to an anchor access network. The method also includes causing a reservation for network resources for the second access network and the third access network by the anchor access network. Moreover, the method includes selecting the second access network as a selected target network. In addition, the method includes sending within a first time frame a from the first access network to the second access network at least a signal indicating that the second access network is selected. Moreover, the method includes sending within the first time frame from the first access network to the third access network and the anchor access network at least a request for releasing reserved network resources. Furthermore, the method includes sending a registration request by the second access network to the anchor access network.

According to yet another embodiment, the present invention provides a system for providing wireless network communication. The system includes a wireless device. The system also includes a serving access network that is configured to provide a network access for the wireless device. The system additionally includes an anchoring access network that is configured to allocate network resources. Also, the system includes a plurality of target access networks that includes at least a first target access network and a second access network. The serving access network is configured to sends a request to the plurality of target access networks for a handover process. The anchoring access network is configured to allocate network resources for the plurality of target access networks. The network resources is associated with the handover process. The first target access network is configured to provide the network access for the wireless in response to a first indication that the first target access network is selected for serving the wireless device. The second target access network is configured to cause a release of network resources that are associated with providing the network access to the wireless device in response to a second indication that the second target access network is not selected for serving the wireless device.

It is to be appreciated that the various embodiments of the present invention provide advantages over conventional techniques. In various embodiments, the present invention allows valuable network resources to be allocated for better use. For example, by releasing network resources reserved for handover processes early, the released network resources may be allocated for other uses. In addition, it is to be appreciated that embodiments of the present invention can be implemented for conventional network techniques and standards. For example, various embodiments of the present invention are compatible with conventional techniques and easily implemented. There are other benefits as well.

Depending upon embodiment, one or more of these benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram illustrating a conventional telecommunication network.

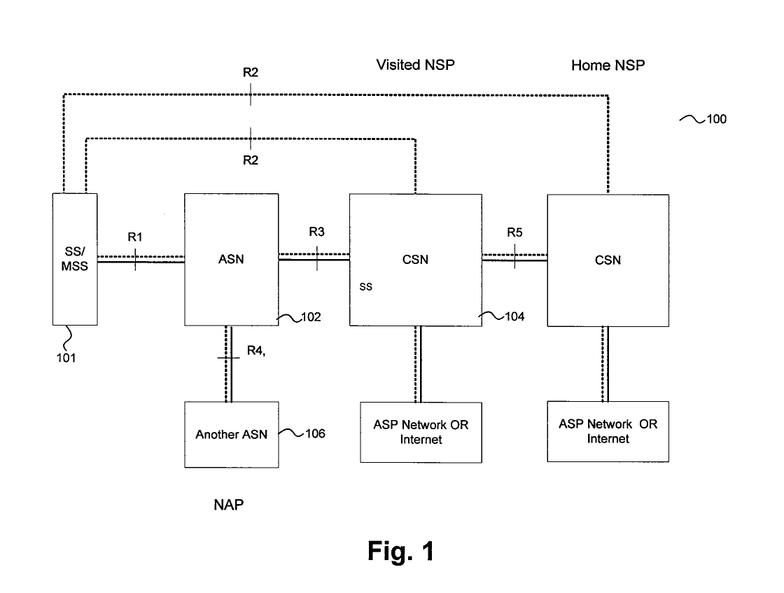

FIG. 2 is a simplified diagram illustrating the preparation phase in a handover process according to a conventional technique.

FIG. 3 is a simplified diagram illustrating the action phase in a handover process according to a conventional technique.

FIG. 4 is a simplified diagram illustrating an HO process according to an embodiment of the present invention.

FIG. 5 is a simplified diagram illustrating another HO process according to an embodiment of the present invention.

FIG. 6 is a simplified diagram illustrating yet another HO process according to an embodiment of the present invention.

### DETAILED DESCRIPTION OF THE INVENTION

The present invention relates in general to telecommunication techniques. More particularly, the invention provides a method and system for providing allocation of network resources. In a specific embodiment, the present invention provides a method and system for access networks that are potential candidates of handover operations to deallocate network resources under certain predetermined conditions. Merely by way of example, the invention is described as it applies to wireless access network, but it should be recognized that the invention has a broader range of applicability.

As explained above, various conventional techniques for performing HO process are often inadequate. A more detailed explanation is provided below. It is to be appreciated that various embodiments according to the present invention provide improved systems and methods, thus offering advantages over conventional techniques.

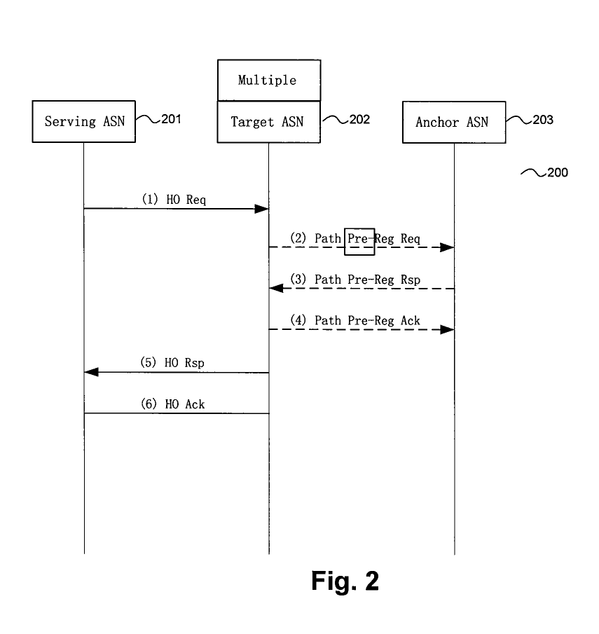

Typically, a conventional HO process includes two phases: (1) preparation phase, and (2) action phase. FIG. 2 is a simplified diagram illustrating the preparation phase in a handover process according to a conventional technique. As shown in FIG. 2, a serving ASN 201, a plurality of target ASN 202, and an anchor ASN 203 are located in a wireless network 200. As an example, the serving ASN 201 is configured to host HO function and to serve the MS prior to HO. The target ASN 202 is configured to provide target HO functions. Often, there are more than one target ASNs. For example, one of the target ASN is selected as the final HO Target and becomes serving ASN after the HO process is completed. The anchor ASN 203 is configured to host the anchor data path (DP) functions for the MS.

During preparation phase, the serving ASN 201 first selects a group of candidate target ASNs 202 for MS to handover. Typically, the selection process for candidate target ASNs is based on various factors, such as location, network policy, capacity, etc. Next, the serving ASN 201 sends handover requests to all of the candidate target ASNs 20, thereby requesting acceptance from the candidate target ASNs 20 for servicing the MS. Based on their individual capability and/or other network status measurements, each of the candidate target ASNs determines whether it is able to serve the switching MS. Typically, each of the candidate target ASNs sends a path pre-registration request to the anchor ASN 203 to reserve network resources (e.g., network path, network bandwidth, etc.). The anchor ASN 203 usually determines the network resources that may be available to the requesting target ASN and sends a response based on that determination. Upon receiving response for the anchor ASN 203, each of the target ASNs sends an acknowledgment to the anchor ASN 203 and an HO response to the serving ASN 201. After receiving the HO response from the candidate target ASNs 202, the serving ASN 201 and/or the MS makes the final selection of the target ASN to handover to.

In order to reduce the data transfer latency during the handover process, candidate target ASNs often establish pre-registration data paths and/or bandwidth with the anchor ASN 203 so that the resource is reserved for the requesting MS. The reserved resources are not actually used for the MS until the MS is actually handover to this ASN. When the MS is switched to a particular target ASN, this target ASN can quickly create the data path for the MS to start forwarding/receiving data without waiting a period for the data path creation. Alternatively, the candidate target ASNs can establish a useable data path with the anchor ASN which anchor ASN can start forwarding the data and buffer for the candidate target ASNs.

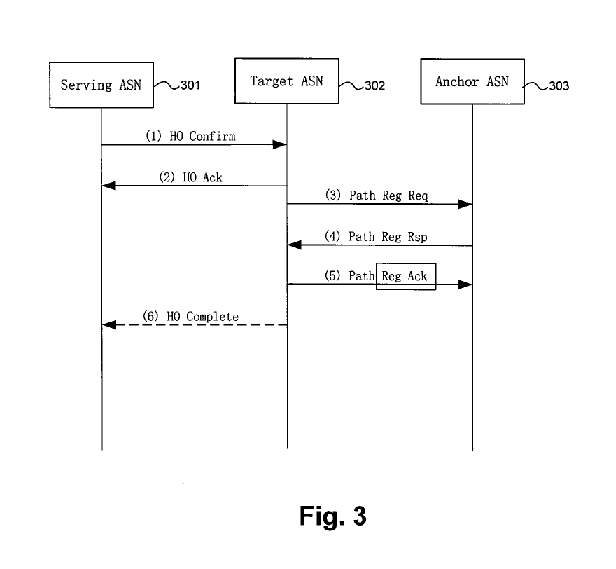

FIG. 3 is a simplified diagram illustrating the action phase in a handover process according to a conventional technique. During the action phase, the following steps are performed:

1. the serving ASN 301 sends an HO confirm message to the target ASN 302;

2. the target ASN 302 sends an acknowledge message to the serving ASN 301;

3. the target ASN 302 sends a path registration request message to the anchor ASN 303;

4. the anchor ASN 303 allocates a path (a previously reserved path) and sends a path request registration response to the target ASN 302;

5. the target ASN 302 sends a registration acknowledgment message to the anchor ASN 303; and

6. the target ASN 302 sends an HO complete message to the serving ASN 301.

Once the target ASN 302 starts servicing the MS, the target ASN 302 becomes the new serving ASN, thus completing the HO process.

The conventional processes as outlined above have been adopted in various forms by different wireless communication standards. For example, the widely used WiMax standard utilizes this type of processes. The pre-allocation of network resources is often advantageous for reducing latency and potential data loss during HO processes. However, there are drawbacks as wells. Among other things, while only one target ASN is actually selected, all of the candidate target ASNs request resource allocation from the anchor ASN. Without proper termination and clean up, network resources requested by unselected target ASNs are often tied up for a long period of time, thus causes network inefficiency and sometimes congestion.

It is therefore to be appreciated that embodiments of the present invention provide mechanisms for promptly releasing network resources that are requested by unselected target ASNs during HO processes.

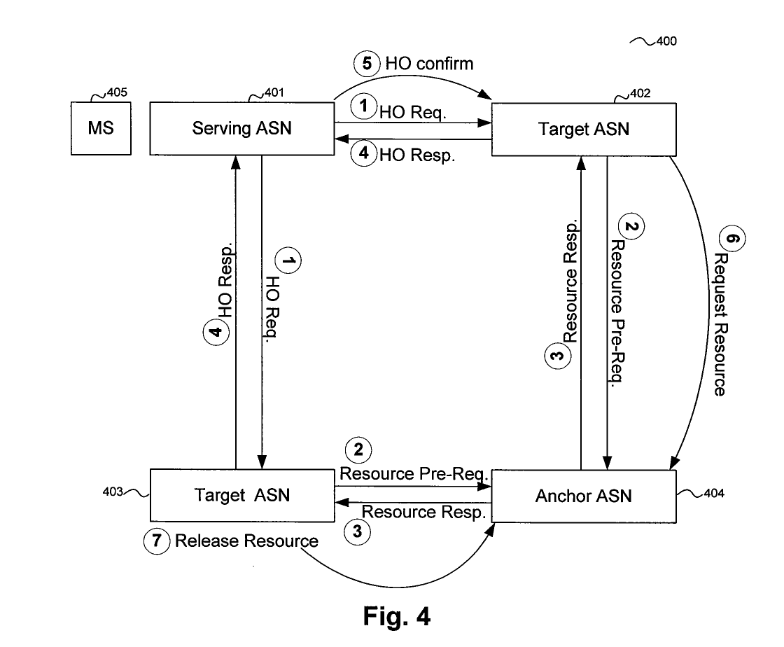

FIG. 4 is a simplified diagram illustrating an HO process according to an embodiment of the present invention. This diagram is merely an example, which should not unduly limit the scope of the claims. One of ordinary skill in the art would recognize many variations, alternatives, and modifications. For example, various steps as illustrated according to FIG. 4 may be added, removed, replaced, rearranged, repeated, overlapped, and/or partially overlapped.

As shown in FIG. 4, a wireless network includes a serving ASN 401, target ASNs 402 and 403, an anchor ASN 404, and a mobile station 405. During an HO process, the following steps are performed.

Step 1: the serving ASN 401 sends an HO request to one or more candidate target ASNs (e.g., ASNs 402 and 403). For example, the serving ASN 401 sends the HO request when it is determined that the mobile station 405 may be leaving the coverage area of the ASN 401.

According to an embodiment of the present invention, the serving ASN sends a timer which the candidate target ASNs can expect to receive the HO confirmation from serving ASN 401. For example, if the timer expires without receiving the HO confirmation from MS or serving ASN, each of the candidate target ASNs may decide to release the network resources that are reserved for the HO process. In a specific embodiment wherein the present invention is practiced under WiMAX standard, the following message field is presented in below:

| IE | Description |
|---|---|
| HO confirmation | The timer which target ASN shall expect to wait for |
| waiting time | the HO confirmation from serving. |

In an alternative embodiment, timer mechanisms are individually implemented for each of the candidate target ASNs. For example, a candidate target ASN initiates a timer when an HO request message is received. If an HO confirm message (i.e., indicating that the target ASN is selected) is not received within a period of time (e.g., 20 seconds), the target ASN release network resources that are reserved for the HO process.

Step 2: the candidate target ASNs send resource pre-registration request to the anchor ASN 404. As explained above, the anchor ASN 404 typically reserve network resources (e.g., data path, bandwidth, etc.) in anticipation of the HO process for the candidate target ASNs. For example, network resources are made readily available to the candidate target ASNs so when the MS 405 switches to a particular target ASN, that target ASN is ready.

In certain embodiments, candidate target ASNs sends a timer to the anchor ASN 404. For example, if the anchor ASN 404 does not receive message from a target ASN indicating that the target ASN has been selected within a time specified by the target ASN, the anchor ASN 404 automatically release network resources reserved for that target ASN when the timer expires. In a specific embodiment wherein the present invention is practiced under WiMAX standard, the following message field is presented in below:

| IE | Description |
|---|---|
| Data path retain | The lifetime of a temporary pre-established or |
| timer | established DP. The DP shall be created and activated |
| | by DP registration process before the timer expires |

In an alternative embodiment, timer mechanisms is implemented by the anchor ASN. For example, the anchor ASN initiates a timer when a pre-registration request is received from a target ASN. If a message (indicating that the target ASN is selected) is not received within a period of time (e.g., 20 seconds), the ASN releases network resources that are reserved for the HO process.

At step 3, the anchor ASN 404 sends responses to each of the candidate target ASNs. For example, each response indicates whether network resources have been reserved.

At step 4, candidate target ASNs send HO responses to the serving ASN 404. Depending upon the specific application, various information may be conveyed in an HO response. For example, an HO response may include information such as the amount of network resource available from each of the candidate target ASNs, network status, etc. Upon receiving HO responses, the serving ASN 401 determines which candidate target ASN will be selected for the purpose of serving the MS 405 after the HO process is completed. For example, the determination process may be based on geographical locations of ASNs, available network resources, etc.

At step 5, the serving ASN 401 sends an HO confirmation message to the selected target ASN (e.g., the target ASN 402). In certain embodiments, the serving ASN 401 also sends messages to unselected candidate target ASNs, indicating that they are not selected.

At step 6, the selected target ASN 402 requests network resources to be actually allocated by the anchor ASN 404. For example, the anchor ASN 404 creates data path for the target ASN 402 in response to the request.

Typically, after the anchor ASN 404 has allocated network resources for the target ASN 402, the anchor ASN 404 sends a response message to the target ASN 402. For example, the response message contains information as what network resources and/or data path the target ASN 402 may use to serve the MS after the HO process is completed. Next, the target ASN 402 sends an HO complete message to the serving ASN 401, which transfers services to the target ASN 402. After the HO process is completed, the target ASN 402 becomes the new serving ASN for the MS.

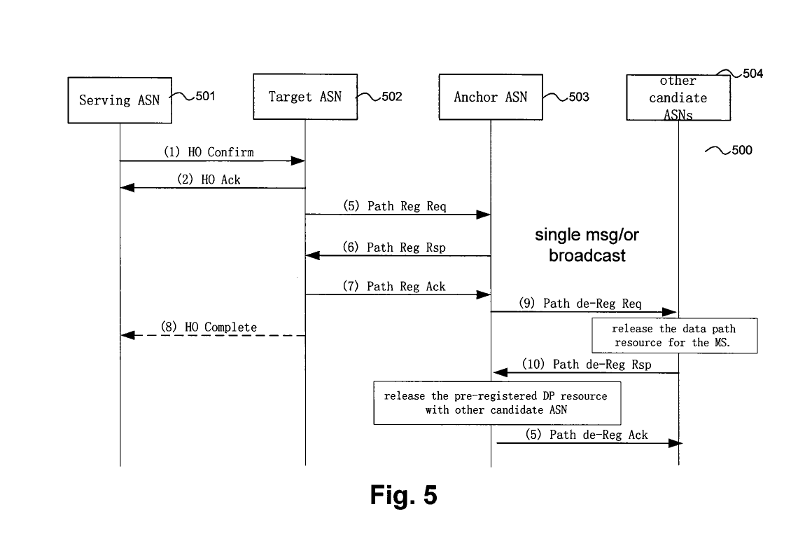

FIG. 5 is a simplified diagram illustrating another HO process according to an embodiment of the present invention. This diagram is merely an example, which should not unduly limit the scope of the claims. One of ordinary skill in the art would recognize many variations, alternatives, and modifications. For example, various steps as illustrated according to FIG. 5 may be added, removed, replaced, rearranged, repeated, overlapped, and/or partially overlapped.

As shown in FIG. 5, a wireless network 500 includes a serving ASN 501, a target ASN 502, an anchor ASN 503, and candidate ASNs 504. For example, the candidate ASNs 504 include one or more ASNs.

During operation, the serving ASN 501 provides network access to a wireless device. For example, the wireless is a mobile station, which may be a cell phone, pager, etc. For various reason, the serving ASN 501 determines that the wireless device needs to be served by a different ASN. The serving ASN 501 initiates a handover process.

Usually, the serving ASN 501 sends a handover request a number of candidate target networks (e.g., target ASN 502 and candidate ASNs 504). In an embodiment, the candidate ASNs send pre-registration requests to the anchor ASN 503. In response to these requests, the anchor ASN 503 reserves network resources for these candidate ASNs. Based on the network registration, the candidate target networks send back information to the serving ASN 501 to indicate whether they are available and/or capable of serving the wireless device for the purpose of the HO process.

The serving ASN 501 then selects one of the candidate ASNs for handing over the service for the wireless device. For the purpose of illustration, the target ASN 502 is selected. Depending on the specific application, the selection by the serving ASN 501 may be based on variety of factors.

After the serving ASN 501 selects the target ASN 502 to serve the wireless device and the HO process, the serving ASN 501 sends an HO confirm indication to the target ASN 502. The target ASN 502 sends an HO acknowledge indication to the serving ASN 501 in response. Next, the target ASN 502 sends a registration request to the anchor ASN 503.

Based on the registration request, the anchor ASN 503 allocates network resources for the target ASN 502 and sends a response indicating that network resources (e.g., data path, bandwidth, processor power, etc.) have been allocated.

Next, the target ASN 502 sends an acknowledge indication to the anchor ASN 503. Then, the target ASN 502 sends an HO complete indication to the serving ASN 501 to indicate that the HO process is completed and the wireless device may be served by the target ASN 502. Once the wireless device switches over, the target ASN 502 becomes the new serving ASN.

Once the anchor ASN 503 receives this acknowledge indication, the anchor ASN 503 sends one or more indications to the candidates ASNs 504 (ones that are not selected for serving the wireless device) to release network resources. In a specific embodiment, the following message (e.g., in compliance with the WiMax standard) is sent from the anchor ASN 503 to the candidate ASNs 504:

| IE | Description |
|---|---|
| Unused pre- | The indicator for the candidate target ASN that the HO |
| established DP | is complete. |
| resource releasing | Bit 0: expected HO confirmation |
| indication | Bit 1: expected DP de-registration request |
| | Bit 2: HO confirmation waiting timer expiration. |

For example, the message includes a de-registration request indication. Depending on the application, message as shown above may be sent in various ways. For example, the anchor ASN 503 sends the message individual to each of the candidate ASNs. As another example, the anchor ASN 503 broadcasts the message to the candidate ASNs.

In response to the de-registration request, each of the candidate ASNs releases their network resources allocated for the wireless device during the HO process. In an embodiment, the candidate ASNs send deregistration requests to the anchor ASN 503, which in turn releases network resources that are allocated for candidate ASNs by the anchor ASN 503. Next, the anchor ASN 503 sends de-registration acknowledge indications to candidate ASNs. Typically, the process of releasing network resources for candidate ASNs are performed within a short time (e.g., 1530 seconds) after the completion of the HO process for conserving valuable network resources.

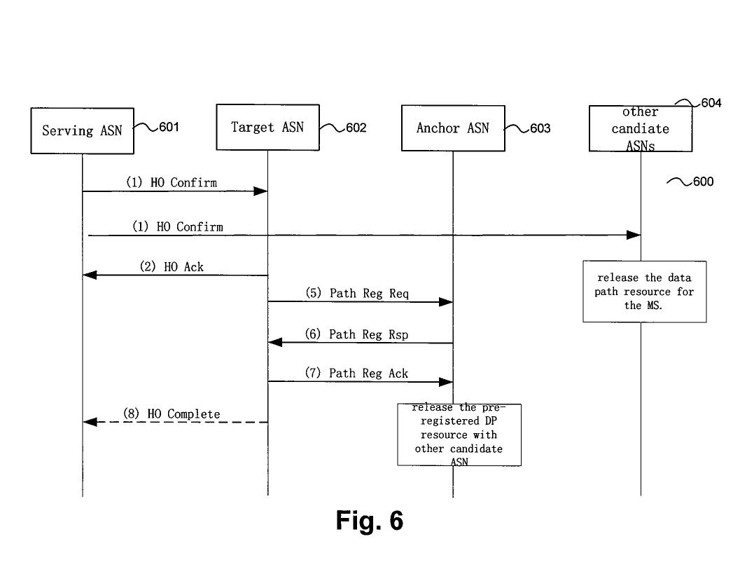

FIG. 6 is a simplified diagram illustrating yet an another HO process according to an embodiment of the present invention. This diagram is merely an example, which should not unduly limit the scope of the claims. One of ordinary skill in the art would recognize many variations, alternatives, and modifications. For example, various steps as illustrated according to FIG. 6 may be added, removed, replaced, rearranged, repeated, overlapped, and/or partially overlapped.

As shown in FIG. 6, a wireless network 600 includes a serving ASN 601, a target ASN 602, an anchor ASN 603, and candidate ASNs 604. For example, the candidate ASNs 604 include one or more ASNs.

During operation, the serving ASN 601 provides network access to a wireless device. For example, the wireless is a mobile station, which may be a cell phone, pager, etc. For various reason, the serving ASN 601 determines that the wireless device needs to be served by a different ASN. The serving ASN 601 initiates a handover process.

Usually, the serving ASN 601 sends a handover request a number of candidate target networks (e.g., target ASN 602 and candidate ASNs 604). In an embodiment, the candidate ASNs send pre-registration requests to the anchor ASN 603. In response to these requests, the anchor ASN 603 reserves network resources for these candidate ASNs. Based on the network registration, the candidate target networks send back information to the serving ASN 601 to indicate whether they are available and/or capable of serving the wireless device for the purpose of the HO process.

The serving ASN 601 then selects one of the candidate ASNs for handing over the service for the wireless device. For the purpose of illustration, the target ASN 602 is selected. Depending on the specific application, the selection by the serving ASN 601 may be based on variety of factors.

After the serving ASN 601 selects the target ASN 602 to serve the wireless device and the HO process, the serving ASN 601 sends an HO confirm indication to the target ASN 602. At approximately the same time, the serving ASN also send indications to candidate ASNs 604 to release network resources. As an example, the serving ASN may send the indication to each candidate ASNs individual and/or to broadcast the indication. Upon receiving the indication, the candidate ASNs 604 initiate processes for releasing. For example, the ASNs 604 releases networks resources that they reserved and/or send request to the anchor ASN 603 to release network resources.

The target ASN 602 sends an HO acknowledge indication to the serving ASN 601 in response. Next, the target ASN 602 sends a registration request to the anchor ASN 603, which in turn allocates resources for the target ASN 602. Once the process is completed, the target ASN 502 becomes the new serving ASN that provides network access to the wireless device.

According to an embodiment, the present invention provides a method for providing allocation of resources in a wireless communication network. The method includes providing network access to a wireless device by a first access network. the method also includes sending a handover request from the first access network to a plurality of candidate target networks at a first time. The plurality of target networks includes at least a second access network and a third access network. The method additionally includes providing at least a timer that is associated with the first time and a second time. The method further includes a step for causing an allocation for network resources by the plurality of the candidate target networks in response to the handover request. Moreover, the method includes a step for selecting the second access network as a selected target network. In addition, the method includes a step for causing a release of at least a portion the network resources by the third access network at the second time. For example, the embodiment is illustrated according to FIG. 4.

According to another embodiment, the present invention provides a method for providing allocation of resources in a wireless communication network. The method includes a step for providing a network access to a wireless device by a first access network. The method further includes sending a handover request from the first access network to a plurality of candidate target networks at a first time. The plurality of target networks includes a second access network and a third access network. The method further includes a step for sending pre-registration requests from the plurality of candidate target networks to an anchor access network. In addition, the method includes a step for causing a reservation for network resources for the second access network and the third access network by the anchor access network. Moreover, the method includes a step for selecting the second access network as a selected target network. Furthermore, the method includes sending a registration request by the second access network to the anchor access network. The method also includes a step for allocating the network resources for the second access network by the anchor access network. Furthermore, the method includes causing a release of network resources reserved for the third access network by the anchor access network. The releasing network resources is associated with the registration request. For example, the embodiment is illustrated according to FIG. 5.

According to yet another embodiment, the present invention provides a method for providing allocation of resources in a wireless communication network. The method includes a step for providing a network access to a wireless device by a first access network. The method additionally includes sending a handover request from the first access network to a plurality of candidate target networks at a first time. The plurality of target networks includes at least a second access network and a third access network. The method further includes sending pre-registration requests from the plurality of candidate target networks to an anchor access network. The method also includes causing a reservation for network resources for the second access network and the third access network by the anchor access network. Moreover, the method includes selecting the second access network as a selected target network. In addition, the method includes sending within a first time frame a from the first access network to the second access network at least a signal indicating that the second access network is selected. Moreover, the method includes sending within the first time frame from the first access network to the third access network and the anchor access network at least a request for releasing reserved network resources. Furthermore, the method includes sending a registration request by the second access network to the anchor access network. For example, the embodiment is illustrated according to FIG. 6.

According to yet another embodiment, the present invention provides a system for providing wireless network communication. The system includes a wireless device. The system also includes a serving access network that is configured to provide a network access for the wireless device. The system additionally includes an anchoring access network that is configured to allocate network resources. Also, the system includes a plurality of target access networks that includes at least a first target access network and a second access network. The serving access network is configured to sends a request to the plurality of target access networks for a handover process. The anchoring access network is configured to allocate network resources for the plurality of target access networks. The network resources is associated with the handover process. The first target access network is configured to provide the network access for the wireless in response to a first indication that the first target access network is selected for serving the wireless device. The second target access network is configured to cause a release of network resources that are associated with providing the network access to the wireless device in response to a second indication that the second target access network is not selected for serving the wireless device. For example, the embodiment is illustrated according to FIG. 4.

It is to be appreciated that the various embodiments of the present invention provide advantages over conventional techniques. In various embodiments, the present invention allows valuable network resources to be allocated for better use. For example, by releasing network resources reserved for handover processes early, the released network resources may be allocated for other uses. In addition, it is to be appreciated that embodiments of the present invention can be implemented for conventional network techniques and standards. For example, various embodiments of the present invention are compatible with conventional techniques and easily implemented. There are other benefits as well.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing allocation of resources in a wireless communication network, the method comprising:
providing network access to a wireless device by a first access network;
sending a handover request from the first access network to a plurality of candidate target networks at a first time, the plurality of target networks including at least a second access network and a third access network;
providing at least a timer, the timer being associated with the first time and a second time;
causing an allocation for network resources by the plurality of the candidate target networks in response to the handover request;
selecting the second access network as a selected target network; and
causing a release of at least a portion the network resources by the third access network at the second time.

2. The method of claim 1 wherein the wireless communication network is in compliance with a standard procedure.

3. The method of claim 1 furthering comprising causing a release of network resources by an anchor network.

4. The method of claim 1 wherein the second time is associated with a release time for deallocating network resources.

5. The method of claim 1 wherein the timer is in accordance with the wireless communication network.

6. The method of claim 1 wherein the providing a timer comprises providing a timer message that is embedded in the handover message.

7. The method of claim 1 wherein the providing at least a timer comprises initiating the timer by the third access network in response to the handover request.

8. The method of claim 1 wherein the network resources comprise a data path.

9. The method of claim 1 further comprising:
providing network access to the wireless device by the second access network; and
terminating network access to the wireless device by the first access network.

10. The method of claim 1 wherein the allocation of for the network resources is performed by an anchor access network, the second access network, or the third access network.

11. The method of claim 1 wherein the timer is provided by the first access network.

12. The method of claim 1 wherein the timer is provided by the third access network in response to the handover request.

13. The method of claim 1 wherein a difference between the first time and the second time is less than twenty seconds.

14. The method of claim 1 wherein the network is a wireless network in compliance with a WiMAX standard.

15. A method for providing allocation of resources in a wireless communication network, the method comprising:
providing a network access to a wireless device by a first access network;
sending a handover request from the first access network to a plurality of candidate target networks at a first time, the plurality of target networks including a second access network and a third access network;
sending pre-registration requests from the plurality of candidate target networks to an anchor access network;
causing a reservation for network resources for the second access network and the third access network by the anchor access network;
selecting the second access network as a selected target network;
sending a registration request by the second access network to the anchor access network;
allocating the network resources for the second access network by the anchor access network; and
causing a release of network resources reserved for the third access network by the anchor access network, the releasing network resources being associated with de-registration request.

16. The method of claim 15 wherein allocation the network resources comprises confirming a reservation of the network resources.

17. The method of claim 15 wherein the allocating the network resources comprises creating a data path for the second access network.

18. The method of claim 15 further comprising sending a request from the anchor access network to the third access network for releasing network resources.

19. The method of claim 15 further comprising sending a signal from the second access network to the first access network indicating that a handover process is complete.

20. The method of claim 15 further comprising providing a network access to the wireless device by the second access network.

21. The method of claim 15 further comprising terminating the network access to the wireless device by the first access network.

22. A method for providing allocation of resources in a wireless communication network, the method comprising:
providing a network access to a wireless device by a first access network;
sending a handover request from the first access network to a plurality of candidate target networks at a first time, the plurality of target networks including at least a second access network and a third access network;
sending pre-registration requests from the plurality of candidate target networks to an anchor access network;
causing a reservation for network resources for the second access network and the third access network by the anchor access network;
selecting the second access network as a selected target network;
sending within a first time frame a from the first access network to the second access network at least a signal indicating that the second access network is selected;
sending within the first time frame from the first access network to the third access network and the anchor access network at least indication that third access network is not selected and the reserved network resources is to be released; and
sending a registration request by the second access network to the anchor access network.

23. The method of claim 22 further comprising causing a release of network resource of anchor data network associated with the third network through a normal resource release message exchange procedure.

24. The method of claim 22 further comprising allocating the network resources for the second access network and the anchor access network.

25. The method of claim 22 wherein the indication comprises a broadcast message indicating that the second access network is selected.

26. The method of claim 22 wherein the indication comprises a broadcast message for releasing network resources.

27. The method of claim 22 wherein the indication comprises a unicast message indicated that the third network is not selected.

28. The method of claim 22 wherein the time frame is less than one second.

29. A system for providing wireless network communication, the system comprising:
a wireless device;
a serving access network being configured to provide a network access for the wireless device;
an anchoring access network being configured to allocate network resources;
a plurality of target access networks including at least a first target access network and a second access network;
wherein:
the serving access network is configured to sends a request to the plurality of target access networks for a handover process;
the anchoring access network is configured to allocate network resources for the plurality of target access networks, the network resources being associated with the handover process;
the first target access network is configured to provide the network access for the wireless in response to a first indication that the first target access network is selected for serving the wireless device;
the second target access network is configured to cause a release of network resources that are associated with providing the network access to the wireless device in response to a second indication that the second target access network is not selected for serving the wireless device.

30. The system of claim 29 wherein the anchoring access network is connected to at least a content service network
